(19) United States
(12) Patent Application Publication
(10) Pub. No.: US 2022/0244693 A1
(43) Pub. Date: Aug. 4, 2022

(54) METHOD FOR OPERATING A FIELD DEVICE USED IN PROCESS AUTOMATION TECHNOLOGY

(71) Applicant: Endress+Hauser Flowtec AG, Reinach (CH)

(72) Inventors: Beat TSCHUDIN, Reinach (CH); Thomas BIER, Riehen (CH); Steffen WEISS, Grenzach-Wyhlen (DE); Bruno WORRETH, Kiffis (FR)

(21) Appl. No.: 17/629,449

(22) PCT Filed: Jul. 10, 2020
(86) PCT No.: PCT/EP2020/069525

§ 371 Date: Jan. 24, 2022

(30) Foreign Application Priority Data
Jul. 25, 2019 (DE) 10 2019 120 199.3

(51) Int. Cl. G05B 19/042; H04W 4/80

(52) U.S. Cl. CPC G05B 19/0423; H04W 4/80; G05B 2219/25201; G05B 2219/25205; G05B 2219/25428

(57) ABSTRACT

The disclosure relates to a method for operating a field device used in process automation technology, wherein the field device has an NFC/RFID transponder, wherein an operating unit comprises an operating system which has an executable operating program, in particular application software, wherein the operating unit has an NFC/RFID reader. The method is characterized in that the NFC/RFID transponder comprises a memory which has data which, when read out using the NFC/RFID reader, triggers the calling up of the operating program in the operating unit.

In automation technology, particularly in process automation technology, field devices serving to capture and/or influence process variables are frequently used. To capture process variables, sensors that are integrated, for example, into fill-level measuring devices, flow measuring devices, pressure and temperature measuring devices, pH-redox potential measuring devices, conductivity measuring devices, etc., are used to capture the corresponding process variables of fill-level, flow, pressure, temperature, pH level, or conductivity. For influencing process variables, actuators, such as, for example, valves or pumps, are used, via which the flow rate of a fluid in a pipeline section or the fill-level in a container can thus be altered. Field devices, in general, refer to all devices which are process-oriented and which supply or process process-relevant information. In connection with the invention, field devices also refer to remote I/O's, radio adapters, or, in general, electronic measuring components that are arranged at the field level.

A field device is in particular selected from a group consisting of flow measuring devices, fill-level measuring devices, pressure measuring devices, temperature measuring devices, limit-level measuring devices, and/or analytical measuring devices.

Flow measuring devices are, in particular, Coriolis, ultrasonic, vortex, thermal, and/or magnetically-inductive flow measuring devices.

Fill-level measuring devices are, in particular, microwave fill-level measuring devices, ultrasonic fill-level measuring devices, time-domain reflectometry fill-level measuring devices, radiometric fill-level measuring devices, capacitive fill-level measuring devices, inductive fill-level measuring devices and/or temperature-sensitive fill-level measuring devices.

Pressure measuring devices are, in particular, absolute, relative, or differential-pressure measuring devices.

Temperature measuring devices are, in particular, measuring devices with thermocouples and/or temperature-dependent resistors.

Limit-level measuring devices are, in particular, vibronic limit-level measuring devices, ultrasonic limit-level measuring devices, and/or capacitive limit-level measuring devices.

Analytical measuring devices are, in particular, pH sensors, conductivity sensors, oxygen and active oxygen sensors, (spectro)photometric sensors, and/or ion-selective electrodes.

EP 1 647 869 A2 discloses an automation system which has an RFID tag with a memory in which identification and operating data are stored. In this case, the data are read out by means of an RFID reading and writing unit integrated into a portable computer unit or a head-mounted display.

Furthermore, application software for smartphones with which field devices can be operated is known from, for example, DE 10 2016 124 739 A1. Due to their easier handling, these are increasingly replacing conventional operating programs. So far, however, the service technician must start the application software on the smartphone and, by selecting the field device to be operated, establish the connections there with the field devices found in the immediate vicinity or already set up.

The aim of the invention is to simplify the operation of field devices with the operating unit. The aim is achieved by the method according to claim 1.

The method according to the invention for operating a field device used in process automation technology,
wherein the field device has an NFC/RFID transponder,
wherein an operating unit comprises an operating system which has an executable operating program, in particular application software,
wherein the operating unit has an NFC/RFID reader,

is characterized in that the NFC/RFID transponder comprises a memory which has data which, when read out using the NFC/RFID reader, triggers the calling up of the operating program in the operating unit.

To date, the operator had to search for and execute the operating program on the operating unit in order to start it. However, process systems often have a plurality of different field devices from different manufacturers, for each of which a separate operating program exists. The present invention makes it possible for the field device to trigger or initiate on the operating unit a call-up or start of the operating program. The operating program compatible with the field device thus already opens when the operating unit is located at a sufficient distance from the field device. The user is spared the cumbersome search for the operating program in a list of the operating unit.

Further advantageous embodiments are part of the dependent claims.

One embodiment provides that the field device have a first communications interface for connecting the field device to a wireless communications network,
wherein the operating unit has a second communications interface for connecting the operating unit to a wireless communications network which is accessible to the operating program,
wherein the data trigger a wireless connection between the field device and the operating unit via the operating program.

To date, the operator had to start the operating program on the operating unit and, by means of the operating program, search for field devices in the surroundings with which he could log in. He selected the field device to which he would like to have access from the list of found field devices. The selection of the field device led him directly to the main page of the field device or to the login window of the field device.

It is advantageous if, by reading out the data stored in the field device, not only is the operating program opened, but also a connection between the operating unit and the field device is automatically established, and the main page assigned to the field device or the login window assigned to the field device is opened in the operating unit. The operator is thus spared a cumbersome search through the field devices existing in the communications network.

One embodiment provides that login data be necessary for the wireless connection between the field device and the operating unit,
wherein the login data are stored in the NFC/RFID transponder and read out using the NFC/RFID reader.

In order to be able to operate a field device, authorization by means of login data is often required in order to thus prevent unauthorized access. With the login data known to him, the user can log in on-site or also via the wireless connection to the field device by entering these data. There are applications in which field devices are installed in areas of use (e.g., explosion-prone areas) where only authorized access is possible. Since authorization has already taken place, it is particularly advantageous if, for operating the field device by means of the operating unit, further authorization is dispensed with. At the same time, however, for operating units in the wireless communications network that are outside the area of use and for whose operators authorization has not yet taken place, authorization shall take place via the operating program. In this case, it is particularly advantageous if the login data are stored in the memory of the field device. These can then be read out by means of the NFC/RFID reader and, in the operating program, taken into account for logging in with the field device. The user is thus spared an additional authorization step.

One embodiment provides that new login data be created by the operating program after each connection,
wherein the new login data are transferred to the NFC/RFID transponder by means of an NFC/RFID writing unit,
wherein the login data already stored in the memory are replaced by the new login data.

For the above field of application, it is advantageous if the stored login data are replaced by newly-generated login data after being read out. This prevents the user from obtaining access to the field device again later outside the area of use without previously having passed through the authorization for the area of use.

One embodiment provides that the login data have a first encryption,
wherein the login data are decrypted by means of the operating program.

For this purpose, a key must be stored in the operating program. This can be available, for example, only to users with special tasks (for example, the technician performing maintenance).

One embodiment provides that the login data be encrypted by means of the operating program so that the encrypted login data have a second encryption that replaces the first encryption,
wherein the login data are transferred with the second encryption to the NFC/RFID transponder by means of an NFC/RFID writing unit and are stored there.

One embodiment provides that, in the event of a deactivated, second communications interface, the data trigger an activation of the second communications interface via the operating system.

To date, the operator of the field device must ensure that the communications interface of the operating unit is switched on before he can establish a wireless connection to the field device. It is advantageous if the stored and read-out data trigger an activation of the second communications interface in the operating unit.

One embodiment provides that, in the event of a deactivated, first communications interface in the field device, the data trigger an activation of the first communications interface via the operating system of the field device.

To date, the operator of the field device must ensure that the communications interface of the field device is switched on before he can establish a wireless connection to the field device. However, this is not always the case, especially not when the field device is battery-operated and/or is in the energy-saving mode. It is advantageous if an activation of the communications interface of the field device is triggered by reading out the data with the operating unit.

In addition to the higher-level units, operating units are often used to operate the field devices. These operating units are either laptops or mobile operating units and are connected to the fieldbus network for communication with the field devices. An example of such a mobile device is the “Field Xpert,” which is produced and marketed by the applicant. Operating programs provide the operator with an easy-to-understand interface with which not only are process data and/or diagnostic data read out, but also changes can be made to the system parameters or an update of the field device can be performed.

Corresponding operating programs are necessary for operating the field devices, which operating programs either run independently on the higher-level units (Endress+Hauser FieldCare, PACTware, AMS Fisher-Rosemount, PDM Siemens) or are also integrated into applications of the control station (Siemens PCS7, ABB Symphony, Emerson Delta V). However, the operating program does not necessarily have to be stored in the memory of the operating unit, but can also be started via a web browser, especially in the case of internet-enabled operating units.

The current trends from the mobile phone and smartphone industry also overlap with the field device market. Nowadays, several manufacturers of field devices already offer special programs, known as application software, or apps for short, for smartphones and other mobile terminals, such as tablets and watches, which enable the operation of field devices by means of such a smartphone via the aforementioned wireless interface of a field device. In contrast to conventional operating methods, these application software solutions frequently offer the advantage that they can be intuitively understood and allow a user to perform most basic operations and/or maintenance functions of a field device in a simple manner. An example of application software is “SmartBlue,” which is made available to the customer by the applicant and with which the customer can connect to the field device via the smartphone in order to read out field-device-specific characteristic data or measurement data.

Field devices are often equipped with additional communications interfaces through which the field devices can be operated via an operating unit by means of an additional communications channel independent of the fieldbus network. These are often special service interfaces, e.g., the CDI interface implemented in the applicant's field devices, or USB interfaces. In addition to such wired connection possibilities, the number of field devices available on the market which have a wireless interface for operating purposes is now increasing. This wireless interface is often designed as a Bluetooth, Zigbee, WirelessHART, or WLAN wireless interface.

The term, “operate,” is understood to mean, inter alia, parameterizing the field device, updating the field device, and/or requesting and visualizing process data and/or diagnostic data of the field device.

The operating program, especially the application software, has access to interfaces of the operating unit, in particular to hardware-side communications interfaces, in order to establish a connection with the field device.

The operating system of the operating unit is Microsoft Windows or an operating system of a mobile terminal, in particular iOS or Android. In addition to iOS and Android, a plurality of other operating systems of smartphones are of course known to the person skilled in the art, such as Windows Phone/Mobile and Linux-based systems.

According to terminology of the applicable standard of the international technology standard ISO/IEC 2382-1 for information technology (since 1993), data are defined as: “a reinterpretable representation of information in a formalized manner, suitable for communication, interpretation, or processing.”

In computing and data processing, data are commonly understood as the (machine-) readable and processable, generally digital representation of information. For this purpose, their content is usually first encoded into characters or character chains, the structure of which follows strict rules, known as syntax. In order to abstract the information again from data, they must be interpreted in a meaning context.

The information in the data is interpreted and executed, where appropriate, in the context of the operating system. The execution of information triggers actions in the operating system, such as activating a communications interface or starting an operating program or application software.

NFC stands for near-field communication and is an international transmission standard based upon RFID technology for contactless exchange of data by electromagnetic induction by means of loosely-coupled coils over short distances of a few centimeters and a data transmission rate of at most 424 kbps.

The transmission takes place either without a connection (with passive HF-RFID transponders according to ISO/IEC 14443 or ISO/IEC 15693) or with a connection (between equivalent active transmitters).

RFID refers to technology for transmitter-receiver systems for automatic and contactless identification and localization of objects and animals using radio waves. An RFID system consists of a transponder (colloquially, also called a tag) which is located on or in the object or animal and contains an identifying code, and a reader for reading out this identifier. Coupling takes place by alternating magnetic fields, generated by the reader, in a short range or by high-frequency radio waves. Not only is data thereby transmitted, but energy is also supplied to the transponder. Active transponders with their own power supply are used to achieve greater ranges. The reader contains an operating system or an operating program that controls the actual reading process, and RFID middleware with interfaces to additional electronic data-processing systems and databases.

The transmission of the identification information takes place in systems standardized according to ISO 18000-1 et seq. as follows: The reader, which, depending upon the type, can optionally also write data, generates a high-frequency, alternating electromagnetic field to which the RFID transponder is exposed. The high-frequency energy it receives via the antenna serves as a power supply for its chip during the communications process. In the case of active RFID transponders, the energy supply can also be provided by an installed battery.

In the case of semi-active RFID transponders, the battery takes over only the supply of the microchip. The RFID transponder can also have a memory with which it communicates.

The microchip in the RFID transponder decodes the commands sent by the reader. The RFID transponder encodes and modulates the response into the radiated electromagnetic field by field-weakening in the contactless short circuit or counterphase reflection of the field emitted by the reader. The transponder thus transmits, for example, its own unchangeable serial number, further data of the marked object, or other information requested by the reader. The transponder itself thus does not generate a field, but rather influences the electromagnetic transmission field of the reader.

There are already modules that have a communications interface in addition to the NFC/RFID transponder and the memory. The NORDIC SEMICONDUCTOR NRF52, for example, also has a Bluetooth communications interface in addition to the NFC/RFID transponder. NRF52 also supports NFC-A. The signal type NFC-A is based upon ISO/IEC 14443A and is similar to RFID type A. In the type-A-based communications delay coding (Miller coding), delay technology is also used, in addition to AM modulation. Binary data with a data rate of approximately 106 kbps are transmitted here via a type-A communication. Here, the binary signal must change from 0% to 100% in order to distinguish between binary 1 and binary 0 data information.

The login data generally comprise at least one universally unique identifier (UUID). The field device can thus be clearly identified in the operating program. Often, the login data additionally comprise a user name or a limited number of user names and/or, if necessary, a password. These data can be read out or requested upon a login.

Access mechanisms, such as entering a password or access key, are well known from the prior art. With the aid of these access mechanisms, it is to be ensured that only authorized persons can access the field device data, especially parameters of the field devices, in order to, for example, edit them. This relates both to direct access to a field device by a human and to access via an operating program.

The invention is explained in greater detail with reference to the following FIGURE. The following is shown:

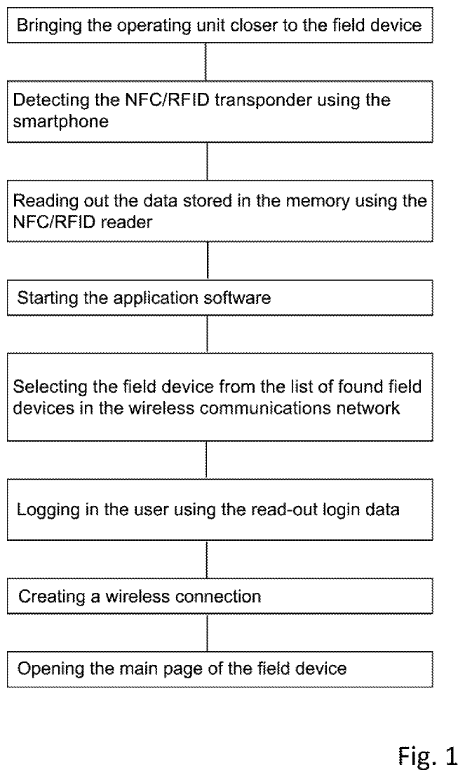

FIG. 1: a flowchart of an embodiment of the method according to the invention for operating a field device.

FIG. 1 shows a flowchart of an embodiment of the method according to the invention. The operator brings his operating unit—in this case, his smartphone—closer to the field device (step 1). If the field device is located at a distance from the field device sufficient for the NFC/RFID transponder installed in the field device to be detected by the smartphone (step 2), the data stored in the memory is simultaneously read out by the NFC/RFID reader (step 3). The operating system interprets and executes the read data, which triggers a start of the operating program—in this case, the application software (step 4). The read-in data additionally comprise a UUID and login information or login data. With this information, the field device in the communications network is selected (step 5), and the operating unit is logged in (step 6). A wireless connection is created upon successful login (step 7). In the event of a successful connection, the application software switches to the main page of the field device (step 8). Previously, all of these steps had to be performed by the operator. According to the invention, the execution of the individual steps is triggered or initiated by the data stored in the field device.

1-8. (canceled)

9. A method for operating a field device used in process automation technology,
wherein the field device has an NFC/RFID transponder,
wherein an operating unit comprises an operating system which has an executable operating program, in particular application software,
wherein the operating unit has an NFC/RFID reader,
characterized in that
the NFC/RFID transponder comprises a memory which has data which, when read out using the NFC/RFID reader, triggers the calling up of the operating program in the operating unit.

10. The method according to claim 9,
wherein the field device has a first communications interface for connecting the field device to a wireless communications network,
wherein the operating unit has a second communications interface for connecting the operating unit to a wireless communications network which is accessible to the operating program,
wherein the data triggers a wireless connection between the field device and the operating unit via the operating program.

11. The method according to claim 9,
wherein login data are necessary for the wireless connection between the field device and the operating unit,
wherein the login data are stored in the NFC/RFID transponder and read out using the NFC/RFID reader.

12. The method according to claim 11,
wherein new login data are created by the operating program after each connection,
wherein the new login data are transferred to the NFC/RFID transponder by means of an NFC/RFID writing unit,
wherein the login data already stored in the memory are replaced by the new login data.

13. The method according to claim 12,
wherein the login data have a first encryption,
wherein the login data are decrypted by means of the operating program.

14. The method according to claim 13,
wherein the login data are encrypted by means of the operating program so that the encrypted login data have a second encryption that replaces the first encryption,
wherein the login data are transferred with the second encryption to the NFC/RFID transponder by means of an NFC/RFID writing unit and are stored there.

15. The method according to claim 9,
wherein, in the event of a deactivated, second communications interface, the data trigger an activation of the second communications interface via the operating system.

16. The method according to claim 9,
wherein, in the event of a deactivated, first communications interface, when reading out the data using the NFC/RFID reader, the operating unit triggers an activation of the first communications interface of the field device.
